(19) United States
(12) Patent Application Publication
(10) Pub. No.: US 2026/0355878 A1
(43) Pub. Date: Nov. 12, 2026

(54) POSITIONING DEVICE

(71) Applicants: CHANG-YI LIN, Taichung (TW); CHANG-CHIH LIN, Taichung (TW)

(72) Inventors: CHANG-YI LIN, Taichung (TW); CHANG-CHIH LIN, Taichung (TW)

(21) Appl. No.: 19/237,263

(22) Filed: Jun. 13, 2025

(30) Foreign Application Priority Data
May 6, 2025 (TW) 114116995

(51) Int. Cl. B23Q 3/10; B23Q 3/02

(52) U.S. Cl. CPC B23Q 3/102; B23Q 3/02

(57) ABSTRACT

A positioning device is provided, wherein the positioning device includes: a main body including positioning holes, a receiving slot and at least one sliding slot; a positioning assembly including two positioning members disposed in and movably along the at least one sliding slot; an adjustment assembly including first and second threaded rods rotatably connected to the main body, and a coupling disposed in the receiving slot, the two positioning members being screwed to a first threaded section of the first threaded rod and a second threaded section of the second threaded rod respectively, the coupling including a first end portion including a third bevel gear, and a second end portion, the third bevel gear being engaged with and between a first bevel gear of the first threaded rod and a second bevel gear of the second threaded rod.

### BACKGROUND OF THE INVENTION

Field of the Invention

The present invention relates to a positioning device.

### Description of the Prior Art

Positioning devices are usually used in fields such as precision machining, CNC machining, mold manufacturing, and five-axis machining, which allows objects (e.g., positioning jigs, vices, clamps, workpieces, tools, molds, etc.) to be positioned accurately such that the objects can be transferred between different positioning devices or repeatedly installed on the same positioning device while maintaining accurate alignment.

In a conventional positioning device, a guide post with a tapered first guiding surface moves axially to push a plurality of steel balls, thereby driving a first and second locking element to lock a first and second plug post. However, the pushing of the steel balls and the steel balls pushing the locking elements involve point-to-point contact. This can lead to uneven force application and deviation of the locking elements during movement, preventing smooth operation and secure locking. Moreover, during installation of the guide post, the alignment with internal steel ball positions must be done without visual confirmation, leading to misalignment.

The present invention is, therefore, arisen to obviate or at least mitigate the above-mentioned disadvantages.

### SUMMARY OF THE INVENTION

The main object of the present invention is to provide a positioning device capable of stably driving two positioning members with stable force application, facilitating installation, and having a simple structure.

To achieve the above and other objects, a positioning device is provided, wherein the positioning device includes: a main body including a plurality of positioning holes, a receiving slot and at least one sliding slot; a positioning assembly including two positioning members, the two positioning members being disposed in the at least one sliding slot, the two positioning members being movably along the at least one sliding slot relative to at least one of the plurality of positioning holes; and an adjustment assembly including a first threaded rod, a second threaded rod and a coupling, the first threaded rod and the second threaded rod being rotatably connected to the main body, the first threaded rod including a first threaded section and a first bevel gear, the second threaded rod including a second threaded section and a second bevel gear, the two positioning members being screwed to the first threaded section and the second threaded section respectively, the coupling being rotatably disposed in the receiving slot, the coupling including a first end portion and a second end portion, the first end portion including a third bevel gear, the third bevel gear facing a first opening of the receiving slot, the second end portion facing a bottom of the receiving slot, and the third bevel gear being engaged with and between the first bevel gear and the second bevel gear.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first exemplary embodiment of the present invention;

FIG. 2 is an exploded view of the first exemplary embodiment;

FIG. 3 is a cross-sectional view showing a positioning member in a releasing position according to the first exemplary embodiment of the present invention;

FIG. 4 is a cross-sectional view showing the positioning member in a locking position according to the first exemplary embodiment of the present invention;

FIG. 5 is a partial enlarged view of FIG. 4;

FIG. 6 is a perspective view of a second exemplary embodiment of the present invention;

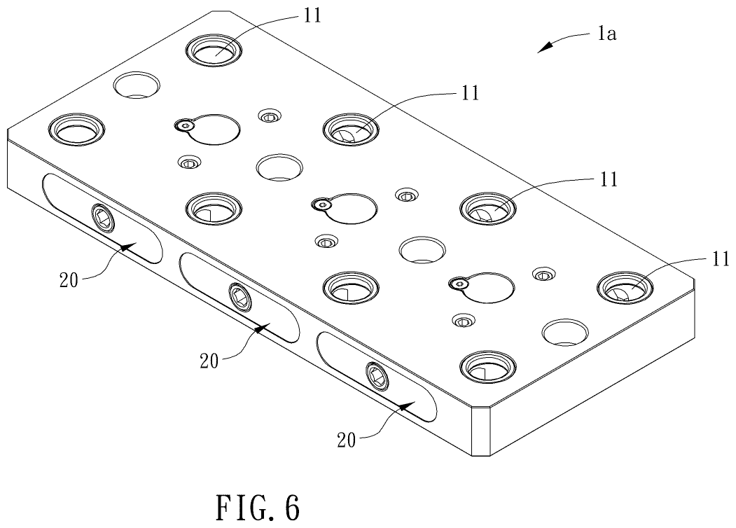

FIG. 7 is an exploded view of the second exemplary embodiment of the present invention; and

FIG. 8 is a cross-sectional view of the second exemplary embodiment of the present invention.

### DETAILED DESCRIPTION OF THE PREFERRED EMBODIMENTS

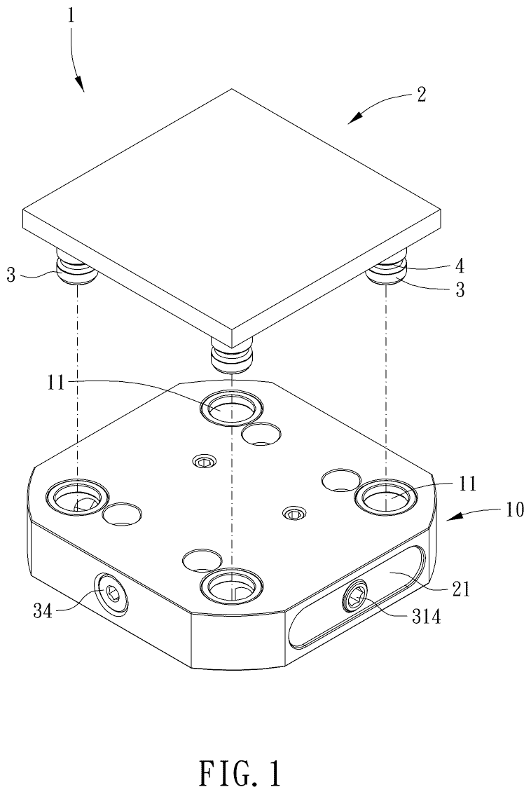

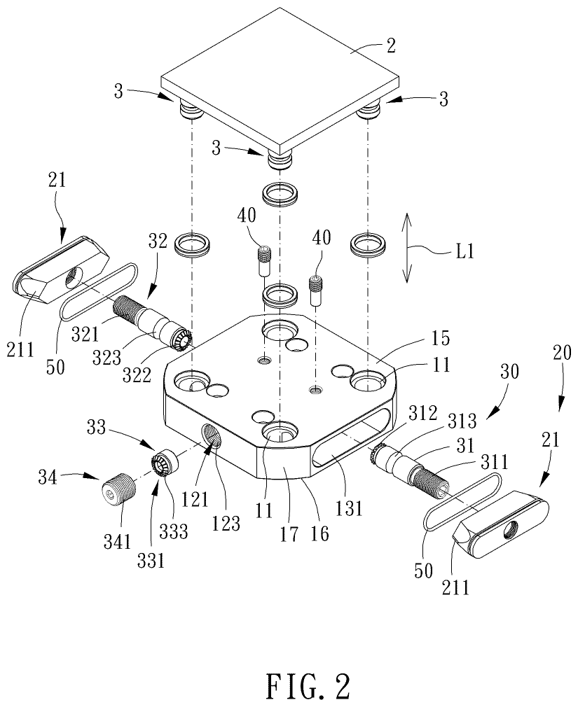

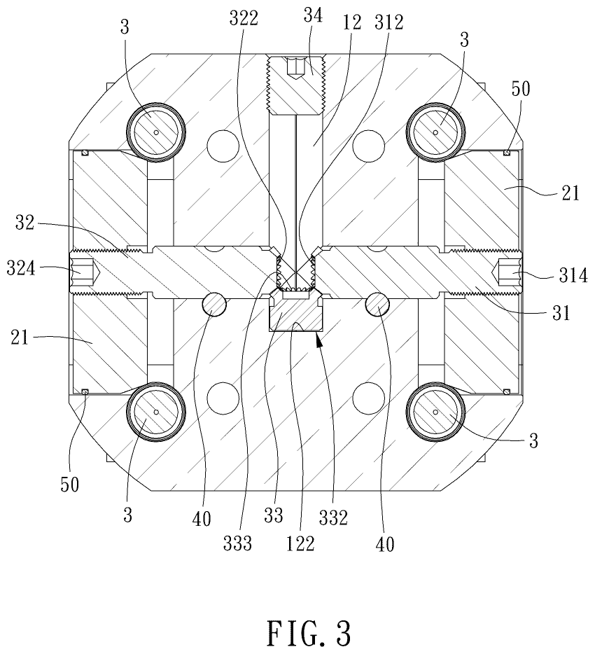

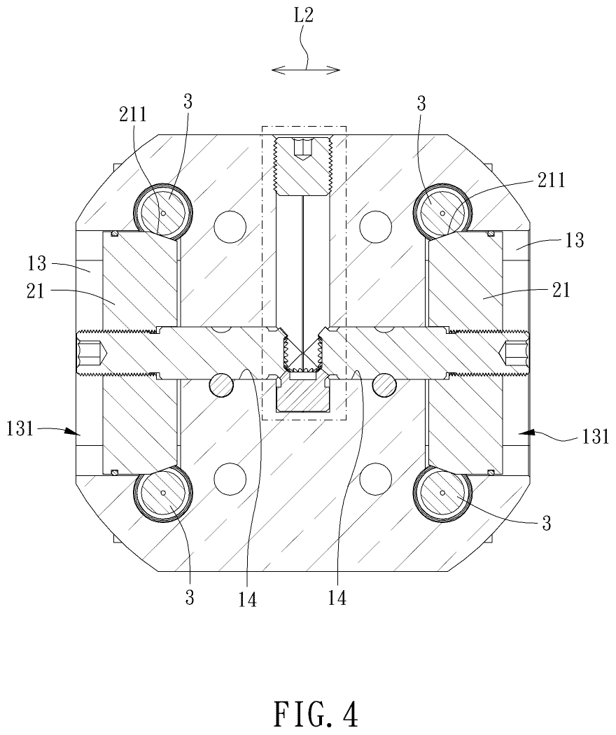

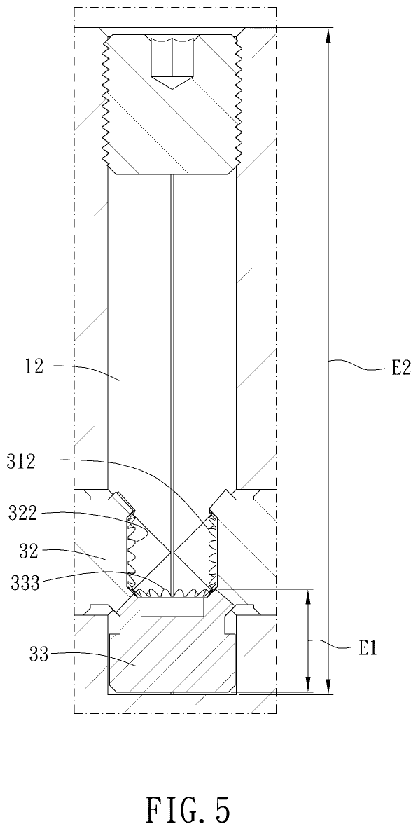

Please refer to FIGS. 1 to 5 for an exemplary embodiment of the present invention. A positioning device 1 of the present invention includes a main body 10, a positioning assembly 20 and an adjustment assembly 30.

The main body 10 includes a plurality of positioning holes 11, a receiving slot (blind slot) 12, and at least one sliding slot 13. The positioning assembly 20 includes two positioning members 21 disposed in the sliding slot(s) 13, and the two positioning members 21 are movably positioned relative to the positioning hole(s) 11. The adjustment assembly 30 includes a first threaded rod 31, a second threaded rod 32, and a coupling 33. The first threaded rod 31 and the second threaded rod 32 are rotatably mounted to the main body 10. The first threaded rod 31 includes a first threaded section 311 and a first bevel gear 312. The second threaded rod 32 includes a second threaded section 321 and a second bevel gear 322. The positioning members 21 are screwed to the first threaded section 311 and the second threaded section 321, and the first threaded section 311 and the second threaded section 321 are helically opposite in direction in this embodiment. The coupling 33 is rotatably mounted in the receiving slot 12 and includes a first end portion 331 and a second end portion 332. The first end portion 331 includes a third bevel gear 333 which faces a first opening 121 of the receiving slot 12. The second end portion 332 faces the bottom 122 of the receiving slot 12. The third bevel gear 333 is engaged with and between the first bevel gear 312 and the second bevel gear 322.

As such, the two positioning members 21 are stably driven with balanced force. The coupling 33 is constrained by the bottom 122 of the receiving slot 12, reducing the number of component and machining process. Additionally, the coupling 33 can be directly viewed through the first opening 121 for gear engagement status and alignment, facilitating accurate assembly. The coupling 33 also abuts the wall of the receiving slot 12, ensuring centered and stable meshing with the bevel gears.

Preferably, a first extent E1 of the coupling 33 is smaller than a second extent E2 of the receiving slot 12 to allow space efficiency and stable rotation.

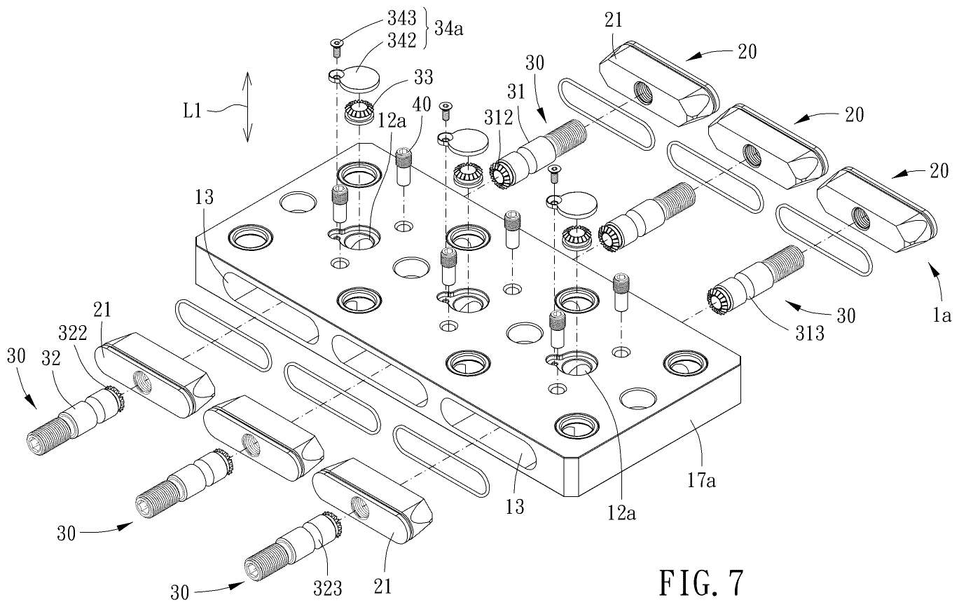

The adjustment assembly 30 further includes a closing member 34 configured to close the first opening 121 to prevent dust and debris, while allowing convenient disassembly. In this embodiment, the wall of the receiving slot 12 includes an internal threaded structure 123 adjacent to the first opening 121. The closing member 34 includes an external threaded structure 341 which is screwed within the internal threaded structure 123. Preferably, the closing member 34 is a set screw. In another embodiment (see FIG. 7), the closing member 34a includes a cover 342 and a fastener 343 to lock the cover 342 to the main body 10a.

In this embodiment, the main body 10 includes two sliding slots 13 disposed on opposite sides and spaced apart in an installation direction L2. The two slots 13 are open in opposite directions of the main body 10. The two positioning members 21 are received in the two slots 13 respectively. The receiving slot 12 extends transversely (vertically in this embodiment) across the installation direction L2 and is positioned between the sliding slots 13. The main body 10 further includes a first end wall 15 and a second end wall 16, and a peripheral wall 17 connected o and between the first end wall 15 and the second end wall 16 in a first direction L1. The two sliding slots 13 are open toward opposite sides of the peripheral wall 17. The positioning members 21 can extend through second openings 131 of the sliding slots 13. Preferably, the main body 10 further includes two receiving holes 14. Each of the two receiving holes 14 extends transversely to the receiving slot 12, and each of the two receiving holes 14 is in communication with and between one of the two sliding slots 13 and the receiving slot 12. The first threaded rod 31 and the second threaded rod 32 are mounted in the receiving holes 14 respectively, and the first bevel gears 312 and the second bevel gear 322 extend in the receiving slot 12. Specifically, the first threaded rod 31 abuts, near the first bevel gear 312, against a wall of one of the receiving holes 14; and the second threaded rod 32 abuts, near the second bevel gear 322, against a wall of another of the receiving holes 14, to achieve stable radial support. Additionally, the first threaded rod 31 is connected to one of the positioning members 21, and the second threaded rod 32 is connected to the other positioning member 21. These two threaded rods can be installed from opposite sides of the main body 10, which facilitates installation.

Specifically, the two positioning members 21 are respectively passable through two second openings 131 of the two sliding slots 13. An end portion of the first threaded rod 31 extends through one of the sliding slots 13 and includes a first connection hole 314 (e.g., an internal hexagonal or Torx hole), and an end portion of the second threaded rod 32 extends through one of the sliding slots 13 and includes a second connection hole 324 (e.g., an internal hexagonal or Torx hole). The first connection hole 314 is exposed to the second opening 131 of one of the sliding slots 13, and the second connection hole 324 is exposed to the second opening 131 of the other sliding slot 13. The first connection hole 314 and the second connection hole 324 are configured for tool connection (e.g., hex wrench or electric driver). In this way, the middle region of the main body 10 has high structural strength (connecting top, bottom, and center), and the two positioning members 21 and the coupling 33 are disposed in their respective independent spaces without mutual interference, which facilitates independent disassembly and avoids being affected.

Preferably, the positioning assembly 20 further includes two rings 50. Each ring 50 is sleeved on one of the positioning members 21 and abuts an inner wall of the sliding slot 13. The two rings 50 are rubber for sealing and anti-slip.

The positioning device 1 further includes a plurality of restriction members 40. The plurality of restriction members 40 are disposed on the main body 10. Specifically, the plurality of restriction members 40 are respectively fastened in a plurality of threaded holes of the main body 10. One of the restriction members 40 abuts the first threaded rod 31 in an extension direction thereof, and another of the restriction members 40 abuts the second threaded rod 32 in an extension direction thereof. Preferably, the first threaded rod 31 includes a first annular groove 313, and the second threaded rod 32 includes a second annular groove 323. The plurality of restriction members 40 are respectively engaged in the first annular groove 313 and the second annular groove 323 to restrict movement of the first threaded rod 31 and the second threaded rod 32 in their extension directions.

Specifically, the plurality of positioning holes 11 are at least partially disposed at corners of at least one sliding slot 13. Each positioning member 21 includes at least one detent portion 211. The plurality of positioning holes 11 are configured to receive a plurality of poles 3 of positioned members 2 (e.g., positioning jig, vise, clamp, workpiece, tool, mold, etc.). The two positioning members 21 are driven by the first threaded rod 31 and the second threaded rod 32 to move relative to the plurality of positioning holes 11 between a locking position and a releasing position. When the two positioning members 21 are in the locking position, the at least one detent portion 211 of each of the positioning members 21 protrudes within one of the positioning holes 11 and engages a groove 4 of one of the poles 3 disposed in the positioning hole 11. When the two positioning members 21 are in the releasing position, the detent portion 211 of each of the positioning members 21 is disengaged from the groove 4 of the pole 3 to achieve quick positioning and release.

During use, one of the first threaded rod 31 and the second threaded rod 32 can be driven to rotate the coupling 33, which in turn drives the other of the first threaded rod 31 and the second threaded rod 32 to rotate. Consequently, the plurality of positioning members 21 are driven to move between the locking position and the releasing position to lock the positioned member 2 in place or to release the positioning members 21.

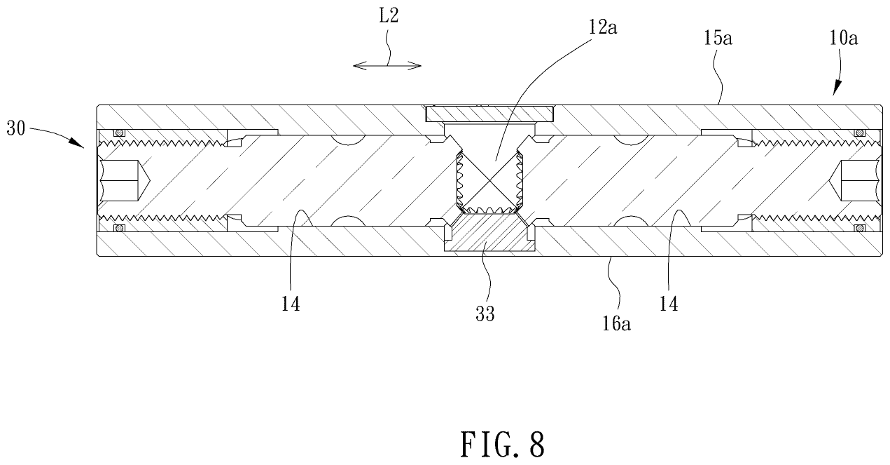

Please refer to FIGS. 7 and 8, which show a second exemplary embodiment of the present invention. The main body 10a includes a plurality of receiving slots 12a and at least four sliding slots 13. The positioning device 1a includes a plurality of positioning assemblies 20 and a plurality of adjustment assemblies 30. The at least four sliding slots 13 are disposed on opposite sides of the main body 10a, and any two of the sliding slots 13 are spaced apart in an installation direction L2. Each of the two sliding slots 13 and are open toward different directions of the main body 10a. The two positioning members 21 of each positioning assembly 20 are disposed in any two of the sliding slots 13. Each receiving slot 12a extends transversely to the installation direction L2 and is located between two of the sliding slots 13. The main body 10a further includes a plurality of receiving holes 14. Each receiving hole 14 extends transversely to one of the receiving slots 12a and is in communication with and between one of the sliding slots 13 and one of the receiving slots 12a. The first threaded rod 31 and the second threaded rod 32 of each adjustment assembly 30 are disposed in any two of the receiving holes 14. The first bevel gear 312 and the second bevel gear 322 extend within the receiving slots 12a, respectively. The positioning device 1a further includes a plurality of restriction members 40 disposed on the main body 10a. One of the restriction members 40 abuts the first threaded rods 31 in an extension direction thereof, and another restriction member 40 abuts the second threaded rods 32 in an extension direction thereof. Each of the first threaded rods 31 includes a first annular groove 313, and each of the second threaded rods 32 includes a second annular groove 323. The plurality of restriction members 40 are respectively engaged within the first annular grooves 313 and the second annular grooves 323 to form a plurality of clamping positions capable of holding and positioning a plurality of poles 3 of a plurality of positioned members 2. In this embodiment, the main body 10a includes a first end wall 15a and a second end wall 16a disposed on opposite sides thereof. A peripheral wall 17a of the main body 10a extends transversely between the first end wall 15a and the second end wall 16a. The first end wall 15a and the second end wall 16a are arranged in the first direction L1. The plurality of positioning holes 11 are arranged in the first direction L1. At least one receiving slot 12a extends in the first direction L1 and is open toward the first end wall 15a, such that the coupling 33 can be inserted from above into the receiving slot 12a and the installation status can be observed from above. Specifically, the opening directions of the plurality of receiving slots 12a may be the same, different, or partially different; for example, some of the opening directions of the plurality of receiving slots 12a are open toward the peripheral wall 17a.

Each adjustment assembly 30 further includes a closing member 34a. The cover 342 of each adjustment assembly 30 closes the first opening 121 of one of the receiving slots 12a. The fastener 343 fastens the cover 342 to the main body 10a. In this embodiment, the fastener 343 is a screw which can be screwed within a threaded hole of the main body 10a to facilitate assembly and disassembly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A positioning device including:
a main body including a plurality of positioning holes, a receiving slot and at least one sliding slot;
a positioning assembly including two positioning members, the two positioning members being disposed in the at least one sliding slot, the two positioning members being movably along the at least one sliding slot relative to at least one of the plurality of positioning holes; and
an adjustment assembly including a first threaded rod, a second threaded rod and a coupling, the first threaded rod and the second threaded rod being rotatably connected to the main body, the first threaded rod including a first threaded section and a first bevel gear, the second threaded rod including a second threaded section and a second bevel gear, the two positioning members being screwed to the first threaded section and the second threaded section respectively, the coupling being rotatably disposed in the receiving slot, the coupling including a first end portion and a second end portion, the first end portion including a third bevel gear, the third bevel gear facing a first opening of the receiving slot, the second end portion facing a bottom of the receiving slot, and the third bevel gear being engaged with and between the first bevel gear and the second bevel gear.

2. The positioning device of claim 1, wherein the adjustment assembly further includes a closing member, and the closing member closes the first opening.

3. The positioning device of claim 1, wherein the at least one sliding slot includes two sliding slots, the two sliding slots are disposed on opposite sides of the main body and spaced apart from each other in an installation direction, the two sliding slots are open in different directions of the main body, the two positioning members are disposed in the two sliding slots respectively, and the receiving slot extends transversely to the installation direction and is located between the two sliding slots.

4. The positioning device of claim 3, wherein the main body further includes two receiving holes, each of the two receiving holes extends transversely to the receiving slot, each of the two receiving holes is in communication with and between one of the two sliding slots and the receiving slot, the first threaded rod and the second threaded rod are disposed in the two receiving holes respectively, and the first bevel gear and the second bevel gear extend into the receiving slot.

5. The positioning device of claim 4, further including a plurality of restriction members, wherein the plurality of restriction members are disposed on the main body, one of the plurality of restriction members abuts against the first threaded rod in an extension direction thereof, and another one of the plurality of restriction members abuts against the second threaded rod in an extension direction thereof.

6. The positioning device of claim 5, wherein the first threaded rod includes a first annular groove, the second threaded rod includes a second annular groove, and the plurality of restriction members are engaged within the first annular groove and the second annular groove respectively.

7. The positioning device of claim 1, wherein the main body includes a first end wall and a second end wall disposed on opposite sides thereof, a peripheral wall of the main body extends transversely between the first end wall and the second end wall, the first end wall and the second end wall are arranged in a first direction, the plurality of positioning holes are arranged in the first direction, and the receiving slot extends in the first direction and is open toward the first end wall.

8. The positioning device of claim 1, wherein the main body includes a plurality of said receiving slots and at least four said sliding slots, and the positioning device includes a plurality of said positioning assemblies and a plurality of said adjustment assemblies.

9. The positioning device of claim 1, wherein the plurality of positioning holes are at least partially disposed at corners of the at least one sliding slot, and each of the two positioning members includes at least one detent portion; the plurality of positioning holes are configured to receive a plurality of poles of positioned members; the two positioning members are driven by the first threaded rod and the second threaded rod to move relative to the plurality of positioning holes between a locking position and a releasing position; when the two positioning members are in the locking position, the at least one detent portion of each of the two positioning members protrudes within one of the plurality of positioning holes and is engaged within a groove of one of the plurality of poles disposed in the positioning hole; and when the two positioning members are in the releasing position, the detent portion of each of the two positioning members is disengaged from the groove of one of the plurality of poles.

10. The positioning device of claim 6, wherein the coupling abuts a wall of the receiving slot adjacent to the third bevel gear; the adjustment assembly further includes a closing member, the closing member closes the first opening; the plurality of positioning holes are at least partially disposed at corners of the at least one sliding slot, and each of the two positioning members includes at least one detent portion; the plurality of positioning holes are configured to receive a plurality of poles of a positioned member; the two positioning members are driven by the first threaded rod and the second threaded rod to move relative to the plurality of positioning holes between a locking position and a releasing position; when the two positioning members are in the locking position, the at least one detent portion of each of the two positioning members protrudes within one of the plurality of positioning holes and is engaged within a groove of one of the plurality of poles disposed in the positioning hole; and when the two positioning members are in the releasing position, the detent portion of each of the two positioning members is disengaged from the groove of one of the plurality of poles; the two positioning members are passable through two second openings of the two sliding slots; an end portion of the first threaded rod extends through one of the two sliding slots and includes a first connection hole, an end portion of the second threaded rod extends through the other sliding slot and includes a second connection hole, the first connection hole is exposed to the second opening of one of the two sliding slots, and the second connection hole is exposed to the second opening of the other of the two sliding slots, and the first connection hole and the second connection hole are configured for tool connection; the positioning assembly further includes two rings, each of the two rings is sleeved onto one of the two positioning members, and each of the two rings abuts an inner peripheral wall of one of the two sliding slots; and a first extent of the coupling is smaller than a second extent of the receiving slot.

11. The positioning device of claim 1, wherein the main body includes a plurality of said receiving slots and at least four said sliding slots, the positioning device includes a plurality of said positioning assemblies and a plurality of said adjustment assemblies; the at least four sliding slots are disposed on opposite sides of the main body, any two of the at least four sliding slots are spaced apart from each other in an installation direction and are open toward different directions of the main body, the positioning members of each of the plurality of said positioning assemblies are disposed in the plurality of said receiving slots respectively, each of the plurality of said receiving slots extends transversely to the installation direction and is located between two of sliding slots; the main body further includes a plurality of receiving holes, each of the two receiving holes extending transversely to each of the receiving slots, and each of the two receiving holes being in communication between one of the at least four sliding slots and one of the receiving slots; the first threaded rod and the second threaded rod of each of the adjustment assemblies are respectively disposed in one of the receiving holes, and the first bevel gear and the second bevel gear each extend within one of the receiving slots; the positioning device further includes a plurality of restriction members, the plurality of restriction members are disposed on the main body, one of the plurality of restriction members abuts the first threaded rod in an extension direction thereof, and another one of the plurality of restriction members abuts the second threaded rod in an extension direction thereof; the first threaded rod includes a first annular groove, and the second threaded rod includes a second annular groove, and the plurality of restriction members are engaged within the first annular groove and the second annular groove respectively.
